(19) United States
(12) Patent Application Publication
(10) Pub. No.: US 2009/0123173 A1
(43) Pub. Date: May 14, 2009

(54) IMAGE FORMING APPARATUS

(76) Inventor: Hideaki KADOWAKI, Soraku-gun (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/254,048

(22) Filed: Oct. 20, 2008

(30) Foreign Application Priority Data
Nov. 13, 2007 (JP) 2007-294026

(51) Int. Cl. G03G 21/20

(52) U.S. Cl. 399/92

(57) ABSTRACT

A photoreceptor 3 is positioned by a photoreceptor positioning member 152 arranged on a backside frame 151 of the main apparatus body and by a photoreceptor drum positioning member 160 on the front side of the main apparatus body. Photoreceptor positioning member 160 formed of metal is united with resinous covers 171 and 172 as duct parts. Each of covers 171 and 172 has an enclosing wall that is bent vertically with respect to its bottom along the outline, so that the enclosing wall of cover 171 and the enclosing wall of cover 172 fit each other, forming a duct 180 therein. Duct 180 is arranged to communicate with a charger 5 via an opening 161 formed in photoreceptor positioning member 160 and cover 171.

This Nonprovisional application claims priority under 35 U.S.C. §119(a) on Patent Application No. 2007-294026 filed in Japan on 13 Nov. 2007, the entire contents of which are hereby incorporated by reference.

### BACKGROUND OF THE INVENTION

(1) Field of the Invention

The present invention relates to an image forming apparatus including a duct mechanism for exhausting ozone, nitrogen oxides (NOₓ) that arise from a charger for electrifying a photoreceptor at a predetermined potential in a copier, printer, facsimile machine or the like.

(2) Description of the Prior Art

In image forming apparatus using an electrophotographic image forming process, a charger is used to uniformly electrify the photoreceptor surface at a predetermined potential. Since this charger electrifies the photoreceptor using corona discharge, ozone and nitrogen oxides (NOₓ) arise as byproducts during discharging. If high-concentration ozone and NOₓ stagnate inside the image forming apparatus and produce oxides on the photoreceptor surface, the surface resistance of the photoreceptor lowers, deteriorating the resolution of the electrostatic latent image and causing image degradation in the electrostatic latent image, called “image flowing”. The oxides thus formed on the photoreceptor surface will cause remarkable reduction in electric resistance under high humidity environment and produce serious image degradation in the printed result. Further, this also causes deterioration of other components than the photoreceptor, shortening the life of the image forming apparatus itself.

Concerning NOₓ, nitrogen oxides react with the moisture in the air, producing nitric acid, also react with metals, producing metal nitrates. Such products exhibit high resistance under low-humidity environment; in particular, when they adhere to a corona discharging electrode, grid electrode or the like, they are prone to cause charging unevenness.

To deal with, technologies that forcibly exhaust discharge byproducts by providing an exhausting mechanism have been proposed. For example, patent document 1 (Japanese Patent Application Laid-open 2001-117472) discloses a configuration in which a duct portion for forming a duct is integrally formed in a base component for supporting an image forming portion including a photoreceptor drum and an electrification charger and in a plate-like component for forming a paper output portion to which paper is discharged. In this configuration, a flow channel is formed by attaching the plate-like component to the base component. The duct is formed with an opening for suctioning air around the photoreceptor drum, and an air flow generated by a blowing fan passes through the vicinity of the photoreceptor drum and flows into the duct through the opening so as to be exhausted.

In the technology of patent document 1, the duct is integrally constructed by the base component and the exterior component, hence it is possible to form the duct without providing extra parts. However, in the image forming apparatus such as a color image forming apparatus that includes a plurality of photoreceptor drums and chargers, a separate duct needs to be provided for each image forming unit, hence the final structure will become complicated and also cause difficulties in making the apparatus compact.

### SUMMARY OF THE INVENTION

In view of the circumstances described above, it is therefore an object of the present invention to provide an image forming apparatus which can be formed with a duct mechanism for exhausting ozone without making the apparatus larger.

It is another object of the present invention to provide a color image forming apparatus including a duct mechanism that can exhaust air from a plurality of chargers through a common duct so as to achieve efficient space usage inside the apparatus.

In accordance with one aspect of the present invention, an image forming apparatus includes: a photoreceptor for forming an electrostatic latent image thereon in accordance with image data and visualizing the electrostatic latent image with toner; a charger for electrifying the photoreceptor at a predetermined potential in order to form the electrostatic latent image; a photoreceptor positioning member for positioning the rotary axis of the photoreceptor; a duct part formed integrally with the photoreceptor positioning member to form a duct that conveys air flow for discharging air from the vicinity of the charger; and, a fan for generating the air flow, and is characterized in that the photoreceptor positioning member and the duct part are formed with an opening at the position opposing the charger, and, the opening enables air around the charger to flow into the duct.

In accordance with another aspect of the present invention, an image forming apparatus includes: an openable exterior housing; a photoreceptor for forming an electrostatic latent image thereon in accordance with image data and visualizing the electrostatic latent image with toner; a charger for electrifying the photoreceptor at a predetermined potential in order to form the electrostatic latent image; a photoreceptor positioning member for positioning the rotary axis of the photoreceptor; a first duct part formed integrally with the photoreceptor positioning member to form a duct that conveys air flow; a second duct part formed integrally with the exterior housing to form the duct that conveys the air flow; and, a fan for generating the air flow, and is characterized in that when the exterior housing is closed, the first duct part and the second duct part are combined to constitute the duct, the photoreceptor positioning member and the first duct part are formed with an opening at the position opposing the charger, and, the opening enables air around the charger to flow into the duct.

The above image forming apparatus may includes a plurality of the photoreceptors and chargers, and is characterized in that the photoreceptor positioning member includes a plurality of positioning portions for positioning the rotary shafts of the plural photoreceptors.

Also, the above image forming apparatus is characterized in that the photoreceptor positioning member includes a moving mechanism for separating the photoreceptor positioning member from the rotary shaft.

According to the present invention, the duct parts are integrally formed with the photoreceptor positioning member and the exterior housing while the opening is arranged at the position opposing the charger, it is hence possible to arrange the mechanism for discharging ozone and nitrogen oxides arising from the charger without enlarging the apparatus.

Also, even when a plurality of photoreceptors and charges are included as in a color image forming apparatus, it is possible to exhaust air using a single common duct. Accordingly, it is possible to provide a duct mechanism which can achieve efficient space usage.

Further, since the moving mechanism for setting and releasing the photoreceptor positioning member with respect to the photoreceptor is provided, it is possible to mount and dismount the photoreceptor in a simple manner by moving together the photoreceptor positioning member and the duct part integrated with it.

### BRIEF DESCRIPTION OF THE DRAWINGS

FIG. 1 is a view showing a schematic configuration of an image forming apparatus according to the present invention;

FIG. 2 is a sectional view showing an exhaust mechanism for an image forming apparatus in the first embodiment;

FIG. 3 is a perspective view showing the first embodiment with all the covers removed;

FIG. 4 is a perspective view showing the first embodiment with a cover 171 attached;

FIG. 5 is a perspective view showing the first embodiment with all covers attached to the image forming apparatus;

FIG. 6 is a view showing the first embodiment with a photoreceptor positioning unit pivotally unfolded;

FIG. 7 is a sectional view showing an exhaust mechanism for an image forming apparatus of the second embodiment; and

FIG. 8 is sectional view showing the embodiment with a front cover opened.

### DESCRIPTION OF THE PREFERRED EMBODIMENTS

The embodiments of the present invention will hereinafter be described in detail with reference to the accompanying drawings.

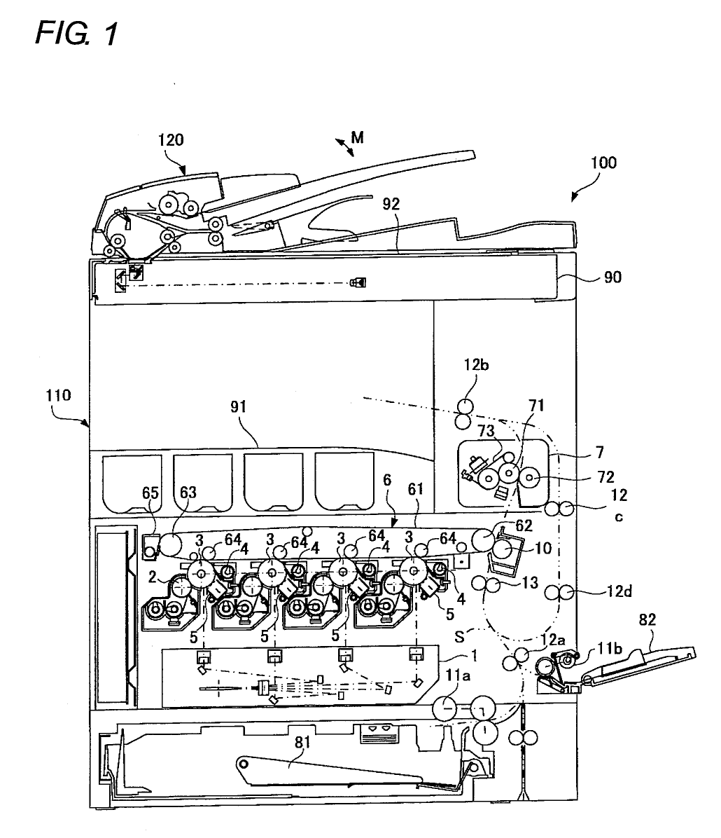

FIG. 1 shows a schematic configuration of an image forming apparatus 100 according to the present invention.

Image forming apparatus 100 forms a multi-colored or monochrome image on a predetermined sheet (recording paper) in accordance with image data transmitted from an external device, and is mainly composed of a main apparatus body 110 and an automatic document processor 120. The main apparatus body 110 includes: an exposure unit 1; developing units 2, photoreceptor drums 3, cleaning units 4, chargers 5, an intermediate transfer belt unit 6, a fuser unit 7, a paper feed cassette 81 and a paper output tray 91.

Arranged on top of main apparatus body 110 is a document table 92 made of a transparent glass plate on which a document is placed. On the top of document table 92, automatic document processor 120 is mounted. Automatic document processor 120 automatically feeds documents onto document table 92. This document processor 120 is constructed so as to be pivotable in the bidirectional arrow M so that a document can be manually placed by opening the top of document table 92.

The image data handled in the image forming apparatus is data for color images of four colors, i.e., black (K), cyan (C), magenta (M) and yellow (Y). Accordingly, four developing units 2, four photoreceptor drums 3, four chargers 5, four cleaning units 4 are provided to produce four electrostatic latent images corresponding to black, cyan, magenta and yellow. That is, four imaging stations are constructed thereby.

Charger 5 is the charging means for uniformly electrifying the photoreceptor drum 3 surface at a predetermined potential. Other than the corona-discharge type chargers shown in FIG. 1, chargers of a contact roller or brush type may also be used.

Exposure unit 1 corresponds to the image writing device of the present invention, and is constructed as a laser scanning unit (LSU) having a laser emitter, reflection mirrors, etc. In this exposure unit 1, a polygon mirror for scanning a laser beam, optical elements such as lenses and mirrors for leading the laser beam reflected off the polygon mirror to photoreceptor drums 3 are laid out. The configuration of the optical scanning unit that constitutes exposure unit 1 will be described later in a specific manner. As exposure unit 1, other methods using an array of light emitting elements such as an EL or LED writing head, for example may be used instead.

This exposure unit 1 has the function of illuminating each of the electrified photoreceptor drums 3 with light in accordance with the input image data to form an electrostatic latent image corresponding to the image data on each photoreceptor drum surface. Developing unit 2 visualizes the electrostatic latent images formed on photoreceptor drums 3 with four color (YMCK) toners. Cleaning unit 4 removes and collects the toner left over on the photoreceptor drum 3 surface after development and image transfer.

Intermediate transfer belt unit 6 arranged over photoreceptor drums 3 is comprised of an intermediate transfer belt 61, an intermediate transfer belt drive roller 62, an intermediate transfer belt driven roller 63, four intermediate transfer rollers 64 corresponding to four YMCK colors and an intermediate transfer belt cleaning unit 65.

Intermediate transfer belt drive roller 62, intermediate transfer belt driven roller 63 and intermediate transfer rollers 64 support and tension intermediate transfer belt 61 to circulatively drive the belt. Each intermediate transfer roller 64 provides a transfer bias to transfer the toner image from photoreceptor drum 3 onto intermediate transfer belt 61.

Intermediate transfer belt 61 is arranged so as to contact with each photoreceptor drum 3. The toner images of different colors formed on photoreceptor drums 3 are sequentially transferred in layers to intermediate transfer belt 61, forming a color toner image (multi-color toner image) on intermediate transfer belt 61. This intermediate transfer belt 61 is an endless film of about 100 μm to 150 μm thick, for example.

Transfer of toner images from photoreceptor drums 3 to intermediate transfer belt 61 are performed by intermediate transfer rollers 64 that are in contact with the rear side of intermediate transfer belt 61. Each intermediate transfer roller 64 has a high-voltage transfer bias (high voltage of a polarity (−) opposite to the polarity (+) of the static charge on the toner) applied thereto in order to transfer the toner image. This intermediate transfer roller 64 is a roller that is formed of a base shaft made of metal (e.g., stainless steel) having a diameter of 8 to 10 mm and a conductive elastic material (e.g., EPDM, foamed urethane or the like) coated on the shaft surface. This conductive elastic material enables uniform application of a high voltage to intermediate transfer belt 61. Though in the present embodiment, rollers are used as the transfer electrodes, brushes or the like can also be used instead.

The visualized electrostatic images of color toners on different photoreceptor drums 3 are laid over one after another on intermediate transfer belt 61. The thus laminated image information is transferred to the paper as intermediate transfer belt 61 and an aftermentioned transfer roller 10 that is arranged at the contact position between the paper and intermediate transfer belt 61 rotate.

In this process, intermediate transfer belt 61 and transfer roller 10 are pressed against each other forming a predetermined nip while a voltage for transferring the toner to the paper (a high voltage of a polarity (+) opposite to the polarity (−) of the static charge on the toner) is applied to transfer roller 10. Further, in order to obtain the above nip at constant, either transfer roller 10 or intermediate transfer belt drive roller 62 is formed of a hard material (metal or the like) while the other is formed of a soft material such as an elastic roller or the like (elastic rubber roller, foamed resin roller etc.).

Since the toner adhering to intermediate transfer belt 61 as the belt comes in contact with photoreceptor drums 3, or the toner which has not been transferred by transfer roller 10 from intermediate transfer belt 61 to the paper and remains thereon, would cause color contamination of toners at the next operation, the remaining toner is adapted to be removed and collected by intermediate transfer belt cleaning unit 65. Intermediate transfer belt cleaning unit 65 includes, for example a cleaning blade as a cleaning member that comes in contact with intermediate transfer belt 61. Intermediate transfer belt 61 is supported from its interior side by intermediate transfer belt driven roller 63, at the portion where this cleaning blade comes into contact with the belt.

Paper feed cassette 81 is a tray for stacking sheets (recording paper) to be used for image forming and is arranged under exposure unit 1 of main apparatus body 110. There is also a manual paper feed cassette 82 on which sheets for image forming can be set. Paper output tray 91 arranged in the upper part of main apparatus body 110 is a tray on which the printed sheets are collected facedown.

Main apparatus body 110 further includes a paper feed path S that extends approximately vertically to convey the sheet from paper feed cassette 81 or manual paper feed cassette 82 to paper output tray 91 by way of transfer roller 10 and fuser unit 7. Arranged along paper feed path S from paper feed cassette 81 or manual paper feed cassette 82 to paper output tray 91 are pickup rollers 11a and 11b, a plurality of feed rollers 12a to 12d, a registration roller 13, transfer roller 10, fuser unit 7 and the like.

Feed rollers 12a to 12d are small rollers for promoting and supporting conveyance of sheets and are arranged at different positions along paper feed path S. On the other hands, pickup roller 11a is arranged near the end of paper feed cassette 81 so as to pick up the paper, sheet by sheet, from paper feed cassette 81 and deliver it to paper feed path S. Similarly, pickup roller 11b is arranged near the end of manual paper feed cassette 82 so as to pick up the paper, sheet by sheet, from manual paper feed cassette 82 and deliver it to paper feed path S.

Registration roller 13 temporarily retains the sheet that is conveyed along paper feed path S. That is, this roller has the function of delivering the sheet toward transfer roller 10 at such a timing that the front end of the paper will meet the front end of the toner image formed on intermediate transfer belt 61.

Fuser unit 7 includes a heat roller 71 and a pressing roller 72. Heat roller 71 and pressing roller 72 are arranged so as to rotate while nipping the sheet. This heater roller 71 is set at a predetermined fusing temperature by the controller in accordance with the signal from an unillustrated temperature detector, and has the function of heating and pressing the toner to the sheet in cooperation with pressing roller 72, so as to thermally fix the toner image transferred on the sheet to the sheet by fusing, mixing and pressing the color image of multiple toners. The fuser unit further includes an external heating belt 73 for heating heat roller 71 from without.

Next, the sheet feed path will be described in detail. As stated above, the image forming apparatus has paper feed cassette 81 for storing sheets beforehand and manual paper feed cassette 82. In order to deliver sheets from these paper feed cassettes 81 and 82, pickup rollers 11a and 11b are arranged so as to lead the paper, sheet by sheet, to feed path S.

The sheet delivered from paper feed cassettes 81 or 82 is conveyed by feed rollers 12a on paper feed path S to registration roller 13, by which the paper is released toward transfer roller 10 at such a timing that the front end of the sheet meets the front end of the image information on intermediate transfer belt 61 so that the image information is transferred to the sheet. Thereafter, the sheet passes through fuser unit 7, whereby the unfixed toner on the sheet is fused by heat and fixed. Then the sheet is discharged through feed rollers 12b arranged downstream, onto paper output tray 91.

The paper feed path described above is that of the sheet for a one-sided printing request. In contrast, when a duplex printing request is given, the sheet with its one side printed passes through fuser unit 7 and is held at its rear end by feed roller 12b, then the feed roller 12b rotates in reverse so as to lead the sheet toward feed rollers 12c and 12d. Thereafter, the sheet passes through registration roller 13 and is printed on its rear side and discharged onto paper output tray 91.

Now, the exhaust mechanism for ozone and nitrogen oxides in the above image forming apparatus will be described.

### The First Embodiment

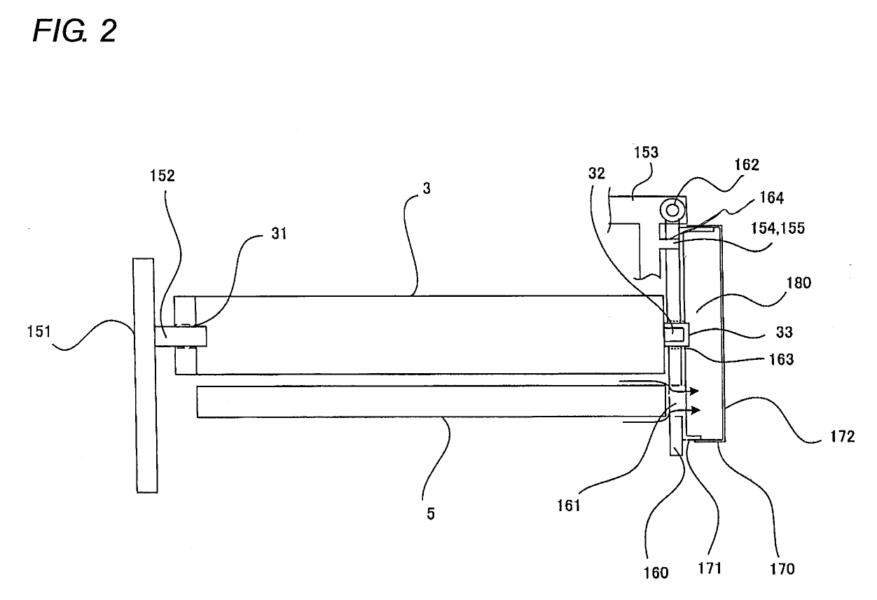

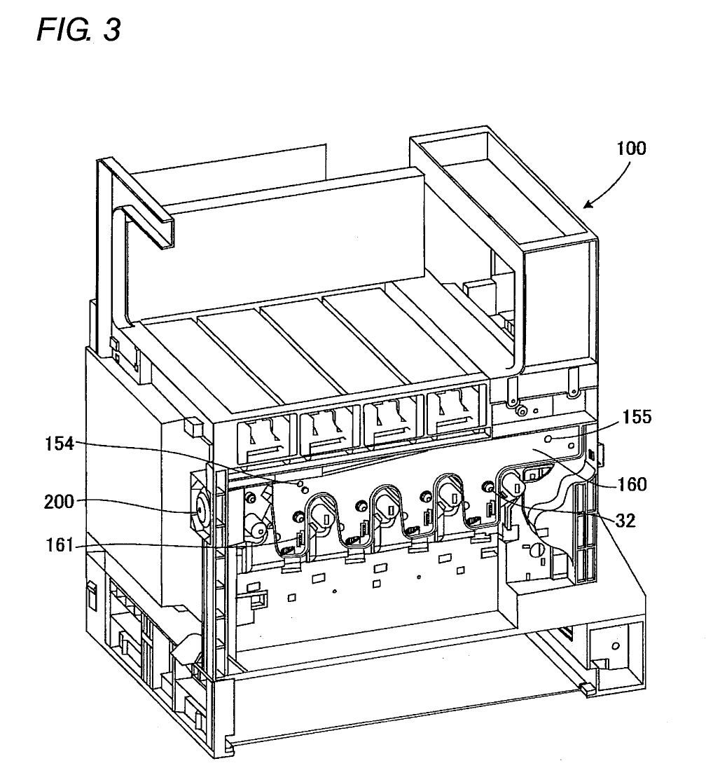

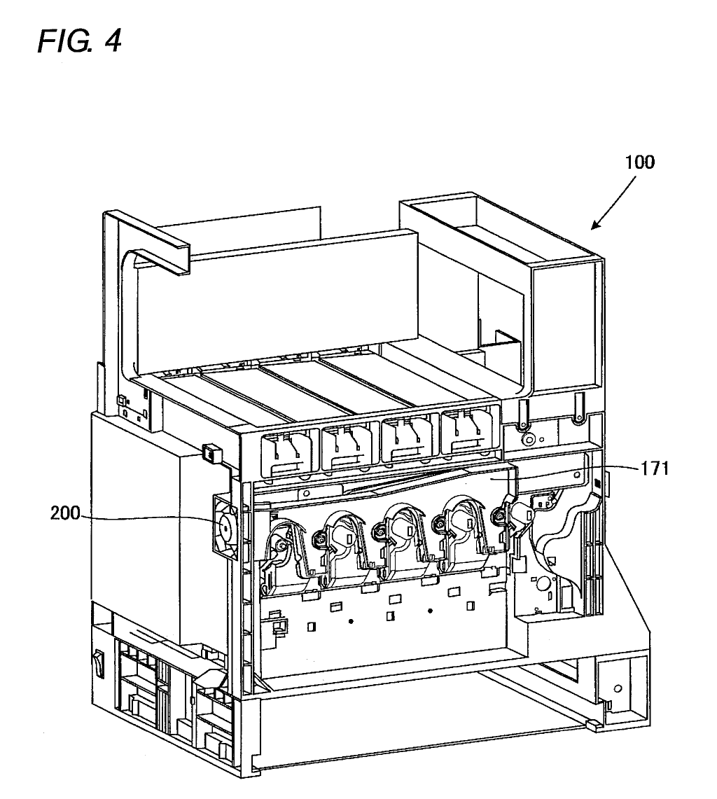

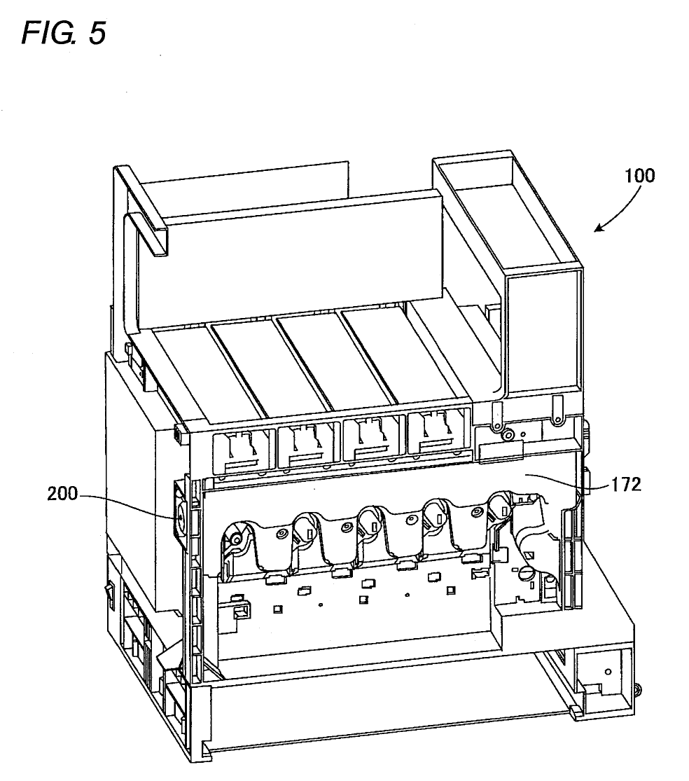

FIG. 2 is a sectional view showing an exhaust mechanism for the image forming apparatus in the first embodiment. FIGS. 3, 4 and 5 are perspective views showing the exhaust mechanism of the image forming apparatus in the first embodiment. FIG. 3 is a perspective view showing a state in which all the covers are removed. FIG. 4 is a view showing a state in which a cover 171 is attached. FIG. 5 is a view showing a state in which all covers are attached to the image forming apparatus.

Photoreceptor 3 is positioned, by a photoreceptor positioning shaft 152 arranged on a backside frame 151 of the main apparatus body, and by a photoreceptor drum positioning member 160 on the front side of the main apparatus body. Formed on the backside end of photoreceptor 3 is a positioning hole 31, into which photoreceptor positioning shaft 152 is inserted to position the photoreceptor. On the front side end of photoreceptor 3, a rotary shaft 32 and a bearing around it are arranged so that rotary shaft 32 is rotatably supported by bearing 33. Rotary shaft 32 and bearing 33 are inserted into a positioning hole 163 formed in a photoreceptor positioning member 160 and a cover 171 (detailed later). That is, photoreceptor 3 is positioned by photoreceptor positioning member 160 through the intermediary of the outside diameter of bearing 33.

Here, bearing 33, photoreceptor 3, charger 5 and cleaner unit 4 may be fixed in a housing of an integrated process unit. Also, a sliding bearing may be used instead of bearing 33.

Photoreceptor positioning member 160 is formed of metal, and is united with resinous covers 171 and 172 as duct parts. Each of covers 171 and 172 has a wall bent vertically with respect to the main covering portion (other than the outline portion) along its outline, so that the enclosing wall of cover 171 and enclosing wall of cover 172 fit each other, forming a duct 180 therein. These photoreceptor positioning member 160, cover 171 and cover 172 constitute a photoreceptor positioning unit 170. The interior enclosed by covers 171 and 172 forms duct 180, which is arranged to communicate with each charger 5 via an opening 161 formed in photoreceptor positioning member 160 and cover 171. Photoreceptor positioning unit 170 has a pivot shaft 162 therein, which is rotatably supported by main body front frame 153 (moving mechanism). Positioning projections 154 and 155 formed on main body front frame 153 fit into positioning holes 164 provided in photoreceptor positioning member 160, so as to fix photoreceptor positioning member 160 to main body front frame 153. In this condition, a fan 200 (FIG. 3) is arranged at one end of duct 180 so as to blow or exhaust air to create air flow.

This fan 200 creates air flow from one duct end to the other. The air flow moving inside duct 180 suctions air through openings 161 formed in photoreceptor positioning member 160 and cover 171 into duct 180. In this way, ozone and nitrogen oxides arising near chargers 5 are flowed into duct 180 through openings 161 and exhausted.

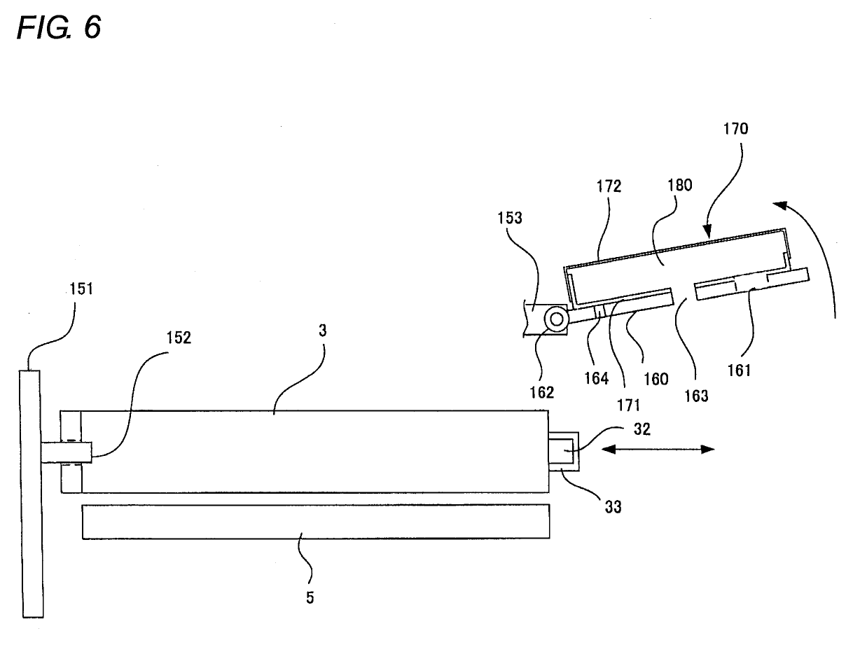

FIG. 6 shows a state in which the photoreceptor positioning unit is pivotally unfolded. In replacing photoreceptors 3, photoreceptor positioning unit 170 is rotated about pivot shaft 162 so as to release rotary shaft 32 of each photoreceptor 3 from positioning hole 163. At the same time, positioning projections 154 and 155 are released from positioning holes 164 of photoreceptor positioning member 160. Under this condition, photoreceptors 3 are removable. Photoreceptor 3 and charger 5 are constructed as an integrated process unit, so that they are removable all together.

In the above way, since covers 171 and 172 as the duct parts are integrally formed with photoreceptor positioning member 160 while opening 161 is arranged at the position opposing charger 5, it is possible to arrange duct 180 for exhausting ozone and nitrogen oxides arising from charger 5 without enlarging the apparatus. Further, even when a plurality of photoreceptors and charges are included as in a color image forming apparatus, it is possible to exhaust air through a single common duct by forming the duct with multiple openings 161 at the positions opposing multiple charges 5. Accordingly, it is possible to provide a duct mechanism which can achieve efficient space usage.

Further, provision of the moving mechanism for releasing photoreceptors 3 in photoreceptor positioning member 160 enables simultaneous movement of photoreceptor positioning member 160 and duct parts 171 and 172 integrally formed therewith. This facilitates the photoreceptors to be mounted and dismounted.

### The Second Embodiment

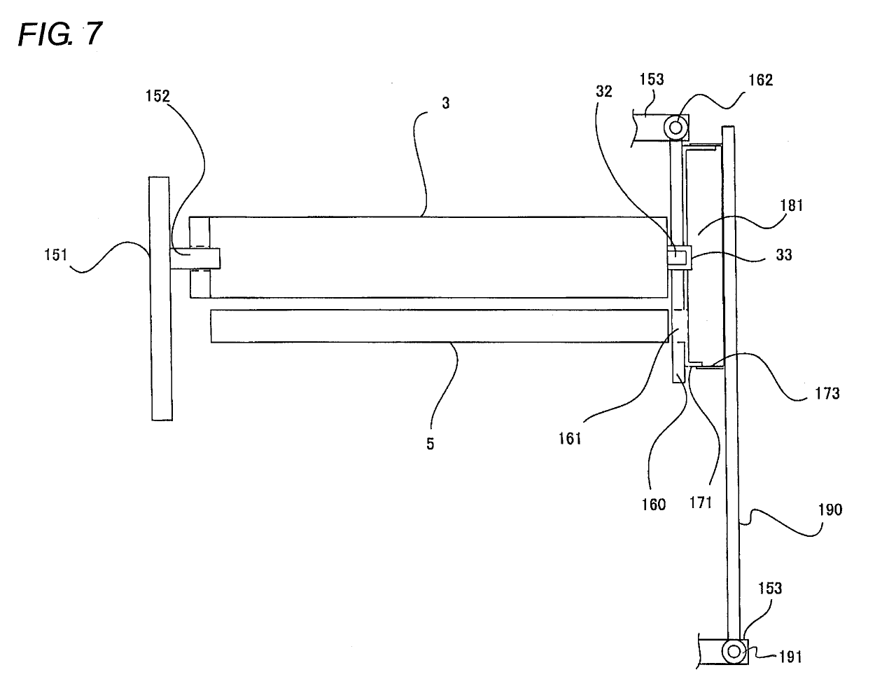

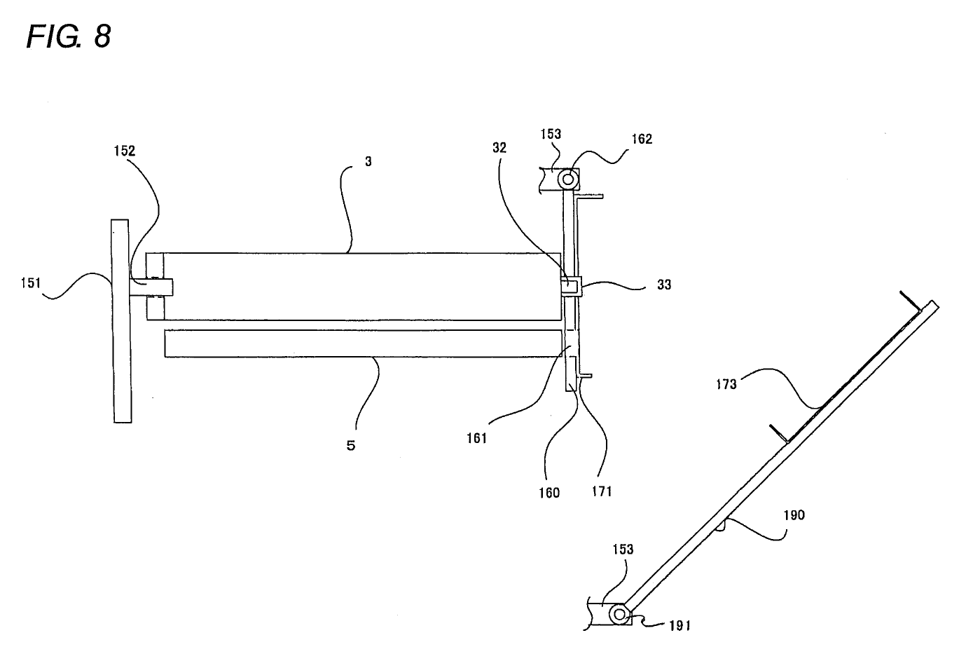

The cover as a duct part may be integrally formed with the external housing front cover of the main apparatus body. FIGS. 7 and 8 are sectional views showing an exhaust mechanism in an image forming apparatus of the second embodiment. FIG. 7 shows an example in which a cover 173 is integrally formed with a front cover 190 of the main apparatus body. This arrangement makes it possible to reduce parts in number. FIG. 8 shows a state in which front cover 190 is opened in the example where cover 173 is integrally formed with front cover 190 of the main apparatus body.

Cover 173 as a duct part is integrally formed with front cover 190 as the exterior housing of the main apparatus body. Cover 173 is formed so that its enclosing wall is bent vertically to front cover 190. Front cover 190 has a pivot shaft 191 formed therewith, which is rotatably supported by main body front frame 153.

When front cover 190 is closed, the enclosing wall of cover 171 and the enclosing wall of cover 173 fit each other forming a duct 181 therein, as shown in FIG. 7. When front cover 190 is opened, cover 171 and cover 173 separate from each other, as shown in FIG. 8.

Since duct parts 171 and 173 are arranged respectively, in pivotable photoreceptor positioning member 160 and in openable front cover 190 as a part of the exterior housing, duct 181 can be formed in the above way when all the components are set in place so that the image forming apparatus can operate. Accordingly, it is possible to form an exhaust mechanism without enlarging the apparatus.

Further, in replacing photoreceptor 3, by opening front cover 190 and moving photoreceptor positioning member 160, the duct parts, or covers 171 and 173 also move so that photoreceptor 3 can be easily replaced.

The present invention should not be limited to the above embodiments. It is obvious that various changes and modifications may be added without departing from the spirit and scope of the invention.

What is claimed is:

1. An image forming apparatus comprising:
a photoreceptor for forming an electrostatic latent image thereon in accordance with image data and visualizing the electrostatic latent image with toner;
a charger for electrifying the photoreceptor at a predetermined potential in order to form the electrostatic latent image;
a photoreceptor positioning member for positioning the rotary axis of the photoreceptor;
a duct part formed integrally with the photoreceptor positioning member to form a duct that conveys air flow for discharging air from the vicinity of the charger; and,
a fan for generating the air flow,
characterized in that
the photoreceptor positioning member and the duct part are formed with an opening at the position opposing the charger, and,
the opening enables air around the charger to flow into the duct.

2. The image forming apparatus according to claim 1, comprising a plurality of the photoreceptors and chargers, characterized in that the photoreceptor positioning member includes a plurality of positioning portions for positioning the rotary shafts of the plural photoreceptors.

3. The image forming apparatus according to claim 1, wherein the photoreceptor positioning member includes a moving mechanism for separating the photoreceptor positioning member from the rotary shaft.

4. An image forming apparatus comprising:
an openable exterior housing;
a photoreceptor for forming an electrostatic latent image thereon in accordance with image data and visualizing the electrostatic latent image with toner;
a charger for electrifying the photoreceptor at a predetermined potential in order to form the electrostatic latent image;
a photoreceptor positioning member for positioning the rotary axis of the photoreceptor;
a first duct part formed integrally with the photoreceptor positioning member to form a duct that conveys air flow;
a second duct part formed integrally with the exterior housing to form the duct that conveys the air flow; and,
a fan for generating the air flow,
characterized in that when the exterior housing is closed, the first duct part and the second duct part are combined to constitute the duct,
the photoreceptor positioning member and the first duct part are formed with an opening at the position opposing the charger, and,
the opening enables air around the charger to flow into the duct.

5. The image forming apparatus according to claim 4, comprising a plurality of the photoreceptors and chargers, characterized in that the photoreceptor positioning member includes a plurality of positioning portions for positioning the rotary shafts of the plural photoreceptors.

6. The image forming apparatus according to claim 4, wherein the photoreceptor positioning member includes a moving mechanism for separating the photoreceptor positioning member from the rotary shaft.
